(19) United States
(12) Patent Application Publication
(10) Pub. No.: US 2025/0202120 A1
(43) Pub. Date: Jun. 19, 2025

(54) Three-Dimensional Superdirective Antenna and Optimization Method

(71) Applicants: Zhejiang University, Hangzhou City (CN); Technology Innovation Institute - Sole Proprietorship LLC, Masdar City (AE)

(72) Inventors: Chongwen HUANG, Hangzhou (CN); Ran JI, Hangzhou (CN); Zhaoyang ZHANG, Hangzhou (CN); Faouzi BADER, Masdar City (AE); Ahmed AL HAMMADI, Masdar City (AE); Mérouane DEBBAH, Madar City (AE)

(73) Assignees: Zhejiang University, Hangzhou City, ZJ (CN); Technology Innovation Institute - Sole Proprietorship LLC, Masdar City (AE)

(21) Appl. No.: 18/981,210

(22) Filed: Dec. 13, 2024

(30) Foreign Application Priority Data
Dec. 19, 2023 (CN) 202311748554.5

(51) Int. Cl. H01Q 9/16; H01Q 21/06; H01Q 21/24

(52) U.S. Cl. CPC H01Q 9/16; H01Q 21/062; H01Q 21/245

(57) ABSTRACT

A three-dimensional (3D) superdirective antenna and optimization method is disclosed herein. The antenna includes: a multilayer substrate, a plurality of radiating elements, and an excitation module. The several radiating elements are mounted on the multilayer substrate to form a 3D radiating element array. The excitation module includes an excitation circuit and a beamforming module that measures radiation fields generated by the array both with and without coupling effects. An embodiment may also generate a coupling matrix based on spherical wave coefficient expansion of the measured radiation fields and determine a superdirective excitation vector based on the coupling matrix. An embodiment may also excite the radiating elements using the excitation vector to generate a superdirective beam. Compared with existing antenna technology, embodiments disclosed herein may dynamically realize a superdirective beam in an alignment direction and demonstrate excellent performance in both directivity and realizable gain.

### CROSS REFERENCE TO RELATED APPLICATIONS

This application claims benefit under 35 U.S.C. § 119 to Chinese Patent Application No. 202311748554.5, filed Dec. 19, 2023, which is incorporated by reference herein in its entirety.

### TECHNICAL FIELD

The present disclosure relates to a stereoscopic array antenna, including a 3D stereoscopic superdirective antenna and an optimization method therefor.

### BACKGROUND

With the development of wireless communication, Multiple Input Multiple Output (MIMO) technology exhibits very powerful capabilities in improving spectral efficiency and wireless communication system capacity, and has become a key technology for increasing 5G communication rates. However, the theoretical capacity analysis of a conventional MIMO array is based on the condition that there is no coupling between antennas, and a physical implementation corresponding to this mathematical condition is that there needs to be an interval of at least a half wavelength (λ/2) between antenna elements of the MIMO array; thus, the spatial aperture area required for large-scale MIMO array deployment is large. However, actual antenna deployment for a base station depends on factors such as scenarios, costs, etc., and there is usually only one fixed total array area. Therefore the number of available antennas of the MIMO array is also limited in actual practice.

Based on the above practical background, a natural direction for technological exploration is to deploy more antenna elements in a given total antenna aperture area, and study whether there is any benefit relative to a conventional MIMO antenna array. In addition, due to advances in the antenna manufacturing process, an antenna array no longer has to be planar. Due to the smaller gap between array elements of emerging 3D stereoscopic superdirective antennas, there is an electromagnetic coupling phenomenon between the array elements, so that a beam vector generated by conventional beamforming methods is distorted after being coupled by the antenna, thereby failing to achieve the intended effect of being directed to the user. In addition, conventional beamforming methods do not take into account the radiation pattern of the antenna elements, and the radiation of a single antenna element is considered isotropic by default. It is difficult for an actual antenna element to generate such a radiation mode. The energy radiation of all common practical antenna elements (e.g., dipole antennas) is spatially non-uniform, and the inherent spatially non-uniform distribution characteristics of the radiation energy of such antennas are not taken into account in currently existing beamforming algorithms. In summary, how to perform low-complexity beamforming while considering both the radiation pattern of the antenna and coupling between antenna array elements, so as to cause a beam of a 3D stereoscopic superdirective antenna to be directed to a user, has become a challenge.

In addition, existing studies have shown that when the interval between antenna array elements is shorter than a half wavelength, a superdirective beam can be generated by reasonably configuring the excitation vector. However, in the case of a linear array, a superdirective beam can be generated only in the end-fire direction, and there is a relatively large loss of radiation efficiency of the antenna in this direction; thus, studies have shown that the effect of superdirectivity is limited for a linear array. How to improve practicability of superdirectivity by means of heterogeneous design of an antenna array to convert a directivity gain into an actual power gain imposes not only requirements on an excitation vector algorithm, but also requirements on radiation efficiency optimization.

### SUMMARY

Based on the above problem, in order to improve beamforming gain and radiation efficiency of a 3D stereoscopic superdirective antenna, as well as generalize an application scenario to a more common and practical multi-directional superdirective multi-user communication model, a method for designing and implementing a 3D stereoscopic superdirective antenna is provided.

Described in the present disclosure is a 3D stereoscopic superdirective antenna, comprising: a multilayer substrate, several radiating elements, and an excitation module, the several radiating elements being mounted on the multilayer substrate to form a 3D stereoscopic radiating element array, the excitation module comprising an excitation circuit and a calculating unit, used to record a radiation field generated when there is no coupling in the 3D stereoscopic radiating element array, and a radiation field in which different radiating elements are individually excited when there is coupling, spherical wave coefficient expansion being performed on the radiation fields before and after coupling, to establish a link between a coupled electromagnetic field and an uncoupled electromagnetic field, to obtain a coupling matrix, and a superdirective excitation vector being calculated according to the coupling matrix, so that the radiating elements are excited by means of the excitation circuit, to realize superdirective beam generation.

Further, the radiating elements are dipole elements, and spatial distribution ensures that intensity of a radiating electric field generated by the antenna along a Z-axis follows a sin(θ) distribution pattern.

Further, recording the radiation field generated when there is no coupling in the array and the radiation field in which the different antenna array elements are individually excited when there is coupling specifically comprises: using an actual spatial position to record the radiation field generated when there is no coupling, uniformly dividing both an elevation angle and a horizontal angle of spherical coordinates, discretizing a space into a number P of directions, and recording θ direction and φ direction electric field intensity of each direction as a radiation field of an array element currently being solved, and recording the radiation field in which the different antenna array elements are individually excited when there is coupling specifically comprises: when configuring excitation of the array, exciting only an antenna array element unit requiring solving, to cause same to generate electromagnetic radiation, the other antenna array elements all being connected to a matching impedance network as a load, likewise discretizing a space into P directions, and recording θ direction and φ direction electric field intensity of each direction as a radiation field of the array element currently being solved.

Further, establishing the link between the coupled electromagnetic field and the uncoupled electromagnetic field specifically comprises: using a linear combination of uncoupled radiating electric fields of a plurality of elements to represent a coupled radiating electric field of a unit element, the total number of antennas at a sending end being N_{T}, an uncoupled radiation field being e₁^{(o)}, e₂^{(o)}, e₃^{(o)}, . . . , e_{N}_{_{T}}^{(o)}, and a coupled radiation field being denoted as e₁^{(c)}, e₂^{(c)}, e₃^{(c)}, . . . , e_{N}_{_{T}}^{(c)}, and linear expressions are:

$$\begin{matrix}{e}_{1}^{( c )} = {c}_{11} {e}_{1}^{( o )} + {c}_{21} {e}_{2}^{( o )} + … + {c}_{{N}_{T} 1} {e}_{{N}_{T}}^{( o )} \\ {e}_{2}^{( c )} = {c}_{12} {e}_{1}^{( o )} + {c}_{22} {e}_{2}^{( o )} + … + {c}_{{N}_{T} 2} {e}_{{N}_{T}}^{( o )} \\ ⋮ \\ {e}_{{N}_{T}}^{( c )} = {c}_{1 {N}_{T}} {e}_{1}^{( o )} + {c}_{2 {N}_{T}} {e}_{2}^{( o )} + … + {c}_{{N}_{T} {N}_{T}} {e}_{{N}_{T}}^{( o )}\end{matrix}$$

the method of substituting the electric field coefficient e therein comprising substituting an actually recorded radiating electric field parameter or spherical wave expansion coefficient, and adjusting the number of expanded items according to a required precision, the physical meaning of a linear combination coefficient cₙₘ being the effect of a radiation field of an n-th antenna element on a radiation field of an m-th antenna when there is coupling; a coupled field being represented by a linear combination of several uncoupled fields, and the above formulas being simplified in the form of a matrix into: E_{N}_{_{T}}^{(c)}=E_{N}_{_{T}}^{(o)}.

E_{N}_{_{T}}^{(c)} is a recorded coupled electric field, E_{N}_{_{T}}^{(o)} is a recorded uncoupled electric field, C is a coupling matrix formed by the coupling coefficient cₙₘ, and if the matrices E_{N}_{_{T}}^{(c)} and E_{N}_{_{T}}^{(o)} are recorded and acquired by means of simulation, a calculation formula of the matrix C is: C=E_{N}_{_{T}}^{(o)}^{^{−1}}E_{N}_{_{T}}^{(c)}.

Further, calculating the superdirective excitation vector according to the coupling matrix comprises: linking a designed excitation vector to an actual equivalent vector by means of the coupling matrix C, so that an excitation vector of a coupled array is an excitation vector of an uncoupled array multiplied by C⁻¹ in order to cause a radiation field of the coupling matrix to conform to a radiation field designed via a conventional beamforming theory; and for a specific array, assuming that an aligned user beam excitation vector designed via a conventional beamforming method is a, an excitation vector of the 3D stereoscopic superdirective antenna being C⁻¹a, wherein a=αZ⁻¹e*, α being an energy normalization coefficient, and expressions of the vector e and the matrix Z being as follows:

$$\begin{matrix}e = {[ {e}^{j κ \hat{r} {r}_{1}} k ( θ , ϕ ) , {e}^{j κ \hat{r} {r}_{2}} k ( θ , ϕ ) , … , {e}^{j κ \hat{r} {r}_{{N}_{T}}} k ( θ , ϕ ) ]}^{T} \\ {z}_{m n} = \frac{1}{4 π} {\int }_{o}^{2 π} {\int }_{o}^{π} {\vert g ( θ , ϕ ) \vert}^{2} {e}^{j κ \hat{r} {r}_{m}} {e}^{- j κ \hat{r} {r}_{n}} sin θ d θ d ϕ\end{matrix}$$

The vector e is an array response vector at the sending end, and the matrix Z is defined as a self-impedance matrix of the antenna array, and is determined by an ideal radiation pattern g (θ, φ) of a single radiating element and geometric positions r₁, . . . , r_{N}_{_{T}} of the radiating elements of the antenna array.

Further, a calculation method of a beam forming module of the sending end is: an array response vector in a multi-user reception communication scenario is an array corresponding vector of a plurality of receiving users corresponding to the sending end, and is equal to the sum of array response vectors calculated independently for each single user.

According to another aspect provided in the present specification, provided is an optimization method based on a 3D stereoscopic superdirective antenna, the method comprising array structure optimization and radiation efficiency optimization; said array structure optimization comprises finding an optimal antenna element interval by means of simulation to achieve an optimal trade-off between radiation efficiency and directivity of a 3D stereoscopic superdirective antenna, and said radiation efficiency optimization specifically comprises adjusting impedance matching by means of iterative optimization, to further improve antenna radiation efficiency.

Further, in the radiation efficiency optimization, iterative optimization specifically comprises: first, obtaining input impedances of different radiating elements in the 3D stereoscopic superdirective antenna by means of simulation, and for each radiating element, configuring a corresponding excitation end pure resistance input impedance to conjugate match a measured impedance of the radiating element in terms of amplitude, then exciting the 3D stereoscopic superdirective antenna to obtain a new input impedance, and repeating this process until radiation efficiency of a radiating element array exceeds a preset threshold or the number of loop optimizations reaches a preset maximum optimization number.

Beneficial effects of the present disclosure are as follows: the 3D stereoscopic superdirective antenna and the analog excitation vector method considering antenna radiation pattern and electromagnetic coupling characteristics consider electromagnetic characteristics more comprehensively than conventional methods, and take into account communication information theory and the actual physical transmission environment. In addition, antenna radiation energy is more focused at a user by means of using a superdirective beam generated by electromagnetic coupling, thereby reducing signal interference between different users while improving communication quality for individual users.

For superdirective beam generation in a single-user scenario of the 3D stereoscopic superdirective antenna, high directivity beam alignment for a single direction can be realized; as a user position changes, calculation related to the antenna array does not need to be performed, and only the azimuth angle of the user needs to be estimated to generate the optimal superdirective beam aligned with the user position.

For beam generation in a multi-user scenario of the 3D stereoscopic superdirective antenna, the provided stereoscopic 3D antenna structure and array excitation vector allow a plurality of superdirective beams to be simultaneously generated and aligned with a plurality of users, respectively, thereby achieving the effect of reducing interference between users while improving energy efficiency utilization and communication quality.

With respect to the problem of radiation efficiency of a 3D stereoscopic superdirective antenna array having electromagnetic coupling not being high, radiation efficiency optimization is performed in two aspects, i.e., antenna array structure design and matching impedance optimization, and a trade-off is made between a theoretical directivity gain and a practically realizable gain, thereby realizing a 3D stereoscopic superdirective antenna having an actual power gain

### BRIEF DESCRIPTION OF THE DRAWINGS

FIG. 1 is a diagram of a communication scenario of a research problem of the present disclosure, and a schematic diagram of a hardware composition of the 3D stereoscopic superdirective antenna.

FIG. 2 is a schematic diagram of a single-layer 3D stereoscopic superdirective antenna according to some embodiments of the present disclosure.

FIG. 3 is a schematic diagram of a multilayer 3D stereoscopic superdirective antenna according to some embodiments of the present disclosure.

FIG. 4 is a conceptual diagram of a physical 3D stereoscopic superdirective antenna according to some embodiments of the present disclosure.

FIG. 5 is a schematic diagram of a unidirectional superdirective beam generated by some embodiments of the present disclosure.

FIG. 6 is a schematic diagram of a multi-directional superdirective beam generated by some embodiments of the present disclosure.

FIG. 7 is a schematic diagram before and after optimizing radiation efficiency via array structure design according to some embodiments of the present disclosure.

FIG. 8 is a schematic diagram of directivity and radiation efficiency of a 3D stereoscopic superdirective antenna changing with an antenna element interval according to some embodiments of the present disclosure.

FIG. 9 is a schematic diagram of gain and radiation efficiency of a 3D stereoscopic superdirective antenna changing with an antenna element interval according to some embodiments of the present disclosure.

FIG. 10 is a schematic diagram of directivity and radiation efficiency of a multilayer 3D stereoscopic superdirective antenna changing with an antenna element interval according to some embodiments of the present disclosure.

FIG. 11 is a schematic diagram of gain and radiation efficiency of a multilayer 3D stereoscopic superdirective antenna changing with an antenna element interval according to some embodiments of the present disclosure.

### DETAILED DESCRIPTION

Embodiments of the present disclosure will be described in further detail below with reference to the accompanying drawings.

Disclosed herein is a 3D stereoscopic superdirective antenna, including: a multilayer substrate, several radiating elements, and an excitation module.

The several radiating elements are mounted on the multilayer substrate to form a 3D stereoscopic radiating element array. The array includes at least one row of a plurality of radiating elements. The array includes at least one row of a plurality of radiating elements. The array is used to generate a radiation field. The excitation module includes an excitation circuit and a beamforming module. The beamforming module is used to generate a superdirective excitation vector (an analog excitation coefficient). The excitation circuit excites the radiating element array, so that an actual spatial beam of the 3D stereoscopic superdirective antenna realizes superdirectivity compared to a theoretical radiation field beam of the array. In any described aspect/embodiment, the plurality of radiating elements may include dual-polarization radiating elements.

In any described aspect/embodiment, each dual-polarization radiating element may provide isolation in a range of about 40 dB to about 50 dB between a transmitting port and a receiving port.

In any described aspect/embodiment, the several radiating elements may include single-polarization radiating elements.

In any described aspect/embodiment, in the 3D stereoscopic superdirective antenna, each excitation output of the excitation module is matched to a corresponding radiating element.

In any described aspect/embodiment, the several radiating elements are arranged at intervals shorter than a half wavelength.

In any described aspect/embodiment, there is a mutual coupling effect between the radiating elements.

In any described aspect/embodiment, the array includes a single row of radiating elements.

In any described aspect/embodiment, the array includes a plurality of rows in the same plane.

In any described aspect/embodiment, the array includes a plurality of rows in different planes.

The excitation module includes an excitation circuit and a calculating unit, used to record a radiation field generated when there is no coupling in the 3D stereoscopic radiating element array, and a radiation field in which different radiating elements are individually excited when there is coupling, spherical wave coefficient expansion being performed on the radiation fields before and after coupling, to establish a link between a coupled electromagnetic field and an uncoupled electromagnetic field, to obtain a coupling matrix, and a superdirective excitation vector being calculated according to the coupling matrix, so that the radiating elements are excited by means of the excitation circuit, to realize superdirective beam generation.

In any described aspect/embodiment, the radiating element may have any radiation pattern.

In any described aspect/embodiment, spherical wave expansion is a spatially complete orthogonal basis function, and can fully describe any electric field distribution.

In any described aspect/embodiment, the radiating element array has an arbitrary antenna interval.

In any described aspect/embodiment, the superdirective array can be aligned in any direction in the space.

The 3D stereoscopic superdirective antenna of the present disclosure is implemented by means of a base station, the base station including a 3D stereoscopic superdirective antenna for transmission and reception in wireless communication. The 3D stereoscopic superdirective antenna includes an array of a plurality of radiating elements.

The array includes at least one row of a plurality of radiating elements, and is used to generate a radiation field. The excitation module further includes the excitation circuit used to provide excitation of the radiating element array, the excitation circuit providing the required excitation to the radiating elements so that the 3D stereoscopic superdirective antenna generates a superdirective beam. The base station further includes a transmitter coupled to the 3D stereoscopic superdirective antenna, and the transmitter is used to provide a transmitted signal. The base station further includes a receiver coupled to the 3D stereoscopic superdirective antenna, and the receiver is used to receive a received signal.

Embodiment 1: Specific implementation steps of an excitation vector scheme of the present disclosure in a communication scenario of transmission by the 3D stereoscopic superdirective antenna and reception by a single user are as follows.

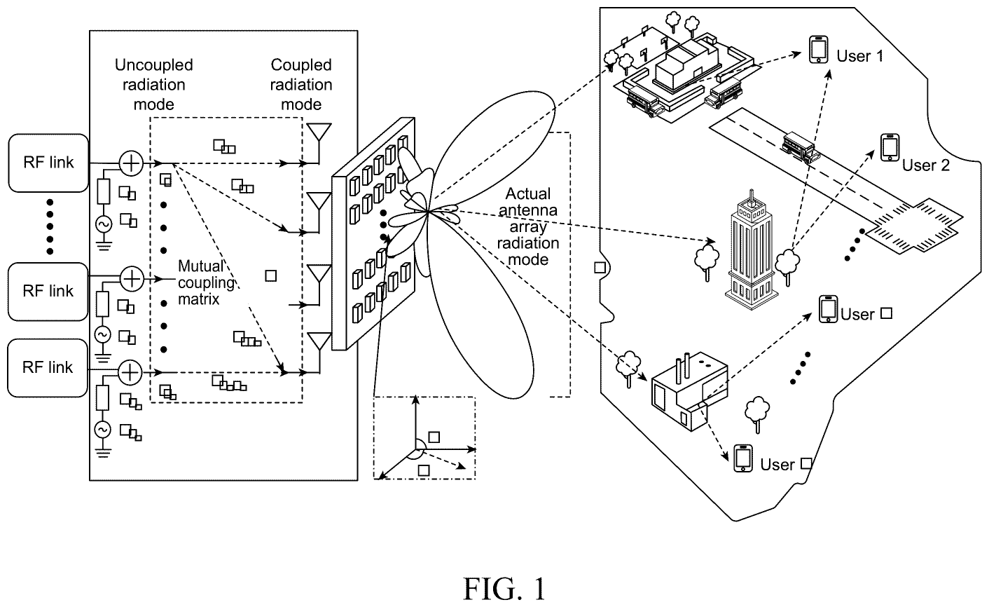

Modeling of a communication scenario of transmission by the 3D stereoscopic superdirective antenna and reception by a single user: As shown in FIG. 1, the present disclosure researched a downlink of a communication system in which a sending end is equipped with the 3D stereoscopic superdirective antenna transmission array, and a single user performs reception at a receiving end. The 3D stereoscopic superdirective antenna is deployed at a base station (BS) end to generate a superdirective beam for a user, thereby improving transmission quality. The 3D stereoscopic superdirective antenna consists of a number Nₜ of densely arranged antenna array elements. It is assumed that the 3D stereoscopic superdirective antenna and a target user are in a random scattering environment, and a direct link and a reflection link via a reflector may be present between the BS and the user. Since the position of the base station is fixed, for the sake of simplicity, it is assumed that two azimuth angles, i.e., an elevation angle and a horizontal angle, of a scatterer relative to the base in the communication environment can be acquired by the base station via a method such as environment sensing or channel estimation. Assuming that there are a number L of scatterers, channel coefficients between the L scatterers and the target user may be represented by a channel vector of L×1.

Superdirective beam generation: Existing beamforming algorithms do not take into account the electromagnetic coupling effect between transmission antennas, and a spatial beam formed when an algorithm is applied to the 3D stereoscopic superdirective antenna is affected by coupling distortion, and cannot be directed to the user. The 3D superdirective antenna excitation vector proposed herein not only alleviates the beam alignment problem, but also enables a superdirective beam to be generated by means of coupling.

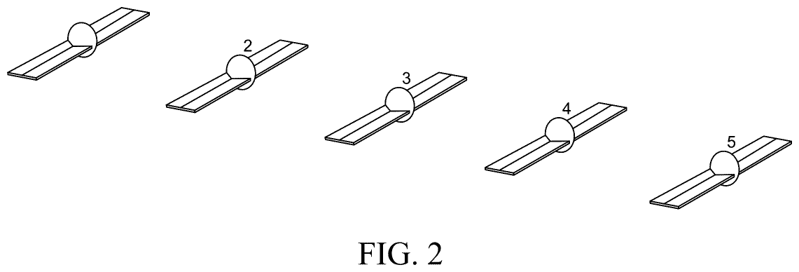

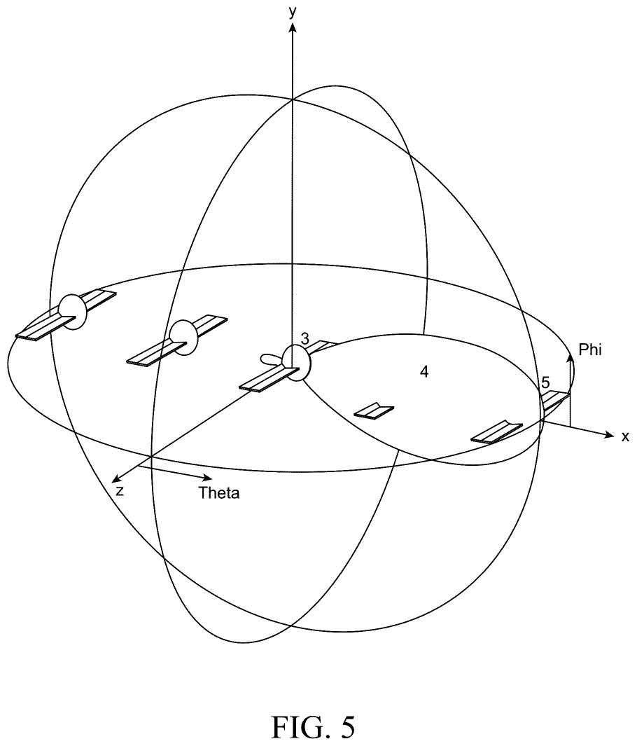

Modeling of the 3D stereoscopic superdirective antenna: First, a dipole array element is modeled in commercial electromagnetic simulation software, and a substrate of an appropriate size is placed below same to meet actual machining requirements. For electromagnetic radiation of a dipole antenna, a well-established analytical expression is already present in the field of electromagnetics. A pattern of a single dipole antenna is simulated by means of the software, and compared with the existing analytical expression in electromagnetic theory, to determine correctness of the modeling. Intensity of a radiating electric field generated by the modeled dipole antenna along the Z-axis follows a sin(θ) distribution pattern, which is consistent with an analytical expression result. A modeled dipole array is then spread out at equal intervals (shorter than a half wavelength) in one plane to form a linear HMIMO array (as shown in FIG. 2), and finally spread out in a perpendicular plane to form a 3D array. Each antenna array element has theoretically the same radiation pattern, but because of coupling effects, the actual radiation pattern of each antenna array element needs to be simulated. An actual manufacturing model of the 3D antenna is shown in FIG. 4, and dipole antenna elements are arranged on each layer of the substrate.

Spherical wave expansion of the radiation pattern: When the 3D stereoscopic superdirective antenna of a dense antenna is modeled, electromagnetic coupling between array elements thereof needs to be calculated. First, radiation patterns generated by all arrays when there is no coupling need to be recorded. Because spatial coordinates of different antenna elements are different, the radiation patterns thereof are the same when there is no coupling. When observed in the near field, intensity and phases of electromagnetic radiation received at the same receiving point from different transmission antennas are different, so that an uncoupled radiation mode thereof needs to be recorded according to actual spatial positions of the antenna array elements after modeling of the 3D stereoscopic superdirective antenna. This is implemented by performing array factor configuration on a single dipole element. In the array factor configuration, spatially linear superposition of the radiation fields of different elements being individually excited can be generated by means of specifying coordinate differences between the different antenna elements and excitation coefficients of the antenna elements. Electric fields generated by the different elements in this manner are dependent only on the spatial positions and the excitation coefficients thereof, so that the coupling effects of other radiating elements are naturally not included. The space is discretized into P directions (both an elevation angle and a horizontal angle of spherical coordinates are uniformly divided), and θ direction and φ direction electric field intensity of each direction is recorded as a radiation field of an array element currently being solved.

Second, it is necessary to calculate the radiation patterns of the different antenna array elements when there is coupling. A simulation method includes: after all the antenna array elements of the 3D stereoscopic superdirective antenna are modeled in the simulation software, when configuring excitation of the array, exciting only an antenna array element unit requiring solving, to cause same to generate electromagnetic radiation, connecting all the other antenna array elements to a matching impedance network as a load, likewise discretizing the space into P directions, and recording θ direction and φ direction electric field intensity of each direction. Further, this process is repeated for all modeled antenna array elements, and a radiation field generated when all the array elements are individually excited is recorded.

Finally, after the radiation fields in the case of coupling and in the case of no coupling are each acquired, the radiation fields can be expanded by means of a spherical wave coefficient:

$$E ( r , θ , ϕ ) = κ \sqrt{Z} {\sum }_{s = 1}^{2} {\sum }_{n = 1}^{N} {\sum }_{m = - n}^{n} {Q}_{s , m , n} , {F}_{s , m , n} ( r , θ , ϕ )$$

$$κ = \frac{2 π}{λ}$$

is the number of waves, λ is the wave length of electromagnetic waves of an operating frequency, Z is a free-space impedance, (r, θ, φ) is a coordinate parameter of a spherical coordinate system, the three parameters (s, n, m) represent an electromagnetic wave mode (TE/TM waves), an electromagnetic wave expansion dimension, and an electromagnetic wave expansion order, respectively, Q_{s,m,n} is a spherical wave expansion coefficient, and F_{s,m,n}(r, θ, ϕ) is a spherical wave function, and as a set of complete basis functions in space, can be used to describe an arbitrary spatial radiation field. Specific expressions thereof are as follows:

$$\begin{matrix}{F}_{m n} ( r , θ , ϕ ) = \frac{1}{\sqrt{2 π}} \frac{1}{\sqrt{n ( n + 1 )}} {( - \frac{m}{\vert m \vert} )}^{m} {z}_{n} ( κ r ) {P}_{n}^{\vert m \vert} ( cos θ ) {e}^{i m ϕ} \\ {F}_{1 mn} ( r , θ , ϕ ) = ∇ {F}_{m n} ( r , θ , ϕ ) \times \hat{r} \\ = \frac{1}{\sqrt{2 π}} \frac{1}{\sqrt{n ( n + 1 )}} {( - \frac{m}{\vert m \vert} )}^{m} \{ {z}_{n} ( κ r ) \frac{i m {P}_{n}^{\vert m \vert} ( cos θ )}{sin θ} {e}^{i m ϕ} {e}_{θ} - {z}_{n} ( κ r ) \frac{i m {P}_{n}^{\vert m \vert} ( cos θ )}{sin θ} {e}^{i m ϕ} {e}_{ϕ} \} \\ {F}_{2 m n} = {κ}^{- 1} ∇ \times {F}_{1 m n} ( r , θ , ϕ )\end{matrix}$$

The spherical wave function is a set of complete basis functions in space, and can be used to describe an arbitrary spatial radiation field.

zₙ(κr) is an n-order type 1 spherical Hankel function, Pₙ^{|m|}(cos θ) is a normalization-related Legendre function, \hat{r} is a unit vector directed to a user in a spherical coordinate system, and e_{θ} and e_{θ} are θ direction and φ direction unit vectors, respectively.

Coupling matrix calculation: After the radiation modes of the 3D stereoscopic superdirective antenna in the case of no coupling and in the case of coupling are each obtained, a coupled radiating electric field of a single element can be represented by a linear combination of uncoupled radiating electric fields of a plurality of elements. If the total number of antennas at a sending end is N_{T}, an uncoupled radiation field is e₁^{(o)}, e₂^{(o)}, e₃^{(o)}, . . . , e_{N}_{_{T}}^{(o)}, and a coupled radiation field is denoted as e₁^{(c)}, e₂^{(c)}, e₃^{(c)}, . . . , e_{N}_{_{T}}^{(c)}. The linear expressions are:

$$\begin{matrix}{e}_{1}^{( c )} = {c}_{11} {e}_{1}^{( o )} + {c}_{21} {e}_{2}^{( o )} + … + {c}_{{N}_{T} 1} {e}_{{N}_{T}}^{( o )} \\ {e}_{2}^{( c )} = {c}_{12} {e}_{1}^{( o )} + {c}_{22} {e}_{2}^{( o )} + … + {c}_{{N}_{T} 2} {e}_{{N}_{T}}^{( o )} \\ ⋮ \\ {e}_{{N}_{T}}^{( c )} = {c}_{1 {N}_{T}} {e}_{1}^{( o )} + {c}_{2 {N}_{T}} {e}_{2}^{( o )} + … + {c}_{{N}_{T} {N}_{T}} {e}_{{N}_{T}}^{( o )}\end{matrix}$$

An electric field coefficient e may be introduced as an actually recorded radiating electric field parameter or a spherical wave expansion coefficient, and can be introduced more flexibly as the spherical wave expansion coefficient; the number of expanded items can be adjusted according to required precision. The physical meaning of a linear combination coefficient cₙₘ is the effect of a radiation field of an n-th antenna element on the radiation field of an m-th antenna when there is coupling. As can be seen from the above definition, a link between a coupled electromagnetic field and an uncoupled electromagnetic field is established by means of the coupling matrix, and a coupled field is represented by a linear combination of a plurality of uncoupled fields. Said plurality of formulas may be simplified in the form of a matrix into: E_{N}_{_{T}}^{(c)}=E_{N}_{_{T}}^{(o)}C.

E_{N}_{_{T}}^{(c)} is a recorded coupled electric field, and E_{N}_{_{T}}^{(o)} is a recorded uncoupled electric field, C being a coupling matrix formed by the coupling coefficient cₙₘ. When the matrices E_{N}_{_{T}}^{(c)} and E_{N}_{_{T}}^{(o)} are recorded and acquired by means simulation, a calculation formula of the matrix C is: C=E_{N}_{_{T}}^{(o)}^{^{−1}}E_{N}_{_{T}}^{(c)}.

The coupling matrix may be derived from a simulation result according to the above process.

### Superdirective Excitation Vector

First, a conventional beamforming design is considered. Since the effect of coupling effects is not considered in the conventional communication model, the excitation vector having undergone conventional beamforming design in the 3D stereoscopic superdirective antenna is not equal to an equivalent excitation vector of an actual antenna array, and the designed excitation vector and the actual equivalent vector are linked via the coupling matrix C. Therefore, an excitation vector of a coupled array is an excitation vector of an uncoupled array multiplied by C⁻¹ in order to cause a radiation field of the coupling matrix to conform to a radiation field designed by means of conventional beamforming theory. For a specific array, assuming that an aligned user beam excitation vector designed by means of a conventional beamforming method is a, an excitation vector of the 3D stereoscopic superdirective antenna (which is also a calculation formula of a beamforming module) is C⁻¹a. a=αZ⁻¹e*, α being an energy normalization coefficient, and expressions of the vector e and the matrix Z being as follows:

$$\begin{matrix}e = {[ {e}^{j κ \hat{r} {r}_{1}} k ( θ , ϕ ) , {e}^{j κ \hat{r} {r}_{2}} k ( θ , ϕ ) , … , {e}^{j κ \hat{r} {r}_{{N}_{T}}} k ( θ , ϕ ) ]}^{T} \\ {z}_{m n} = \frac{1}{4 π} {\int }_{0}^{2 π} {\int }_{0}^{π} {\vert g ( θ , ϕ ) \vert}^{2} {e}^{j κ \hat{r} {r}_{m}} {e}^{- j κ \hat{r} {r}_{n}} sin θ d θ d ϕ\end{matrix}$$

The vector e is an array response vector at the sending end, and the matrix Z is defined as a self-impedance matrix of the antenna array, and is determined by an ideal radiation pattern g (θ, φ) of a single radiating element and geometric positions r₁, . . . , r_{N}_{_{T}} of the radiating elements of the antenna array. An excitation circuit consists of a power divider and a phase shifter. The excitation vector calculated by the beamforming module is realized by adjusting power distribution and a phase of excitation for each antenna respectively. A spatial superdirective beam of a single-user scenario generated by the excitation circuit is as shown in FIG. 5.

### Superdirective Array Radiation Efficiency Optimization

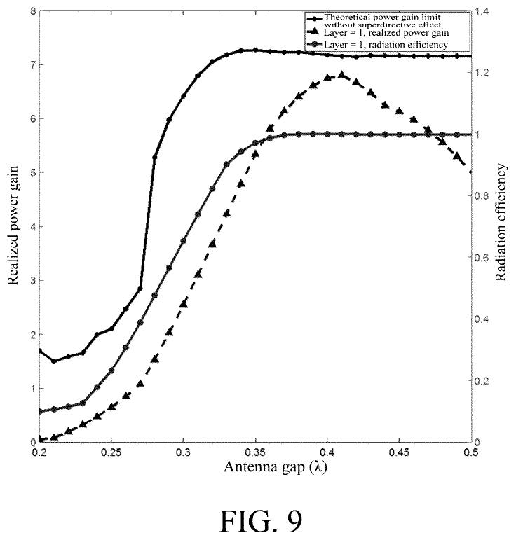

Array structure optimization: Theoretical analysis shows that the directivity which the array can realize increases as the antenna element gap decreases, and for a linear antenna array of N antenna elements, the maximum directivity that can be realized when the element gap d→0 is N². However, it has been found via a simulation experiment that as the element gap d decreases, the coupling effect increases, and antenna radiation efficiency decreases. In addition, a radiation efficiency jump region exists in the range of d=0.35→0.2 (the antenna radiation efficiency decreases sharply). A decrease in antenna radiation efficiency means that an increase directivity does not necessarily result in an improvement in actual energy efficiency, because actually realized antenna power gain=efficiency*Directivity. When the antenna gap is overly large, radiation efficiency is high, but the directivity that can be realized is low. When the antenna gap is overly small, directivity is high, but radiation efficiency is overly low, both of which result in realizable power gain being overly small. Therefore, design of the geometric structure of the array must be optimized. FIG. 9 shows power gains that can be realized with different array gaps. As can be seen from the drawing, when the array gap is about 0.4, the maximum realizable gain is realized for the single-layer 3D stereoscopic superdirective antenna, i.e., an optimal trade-off between the radiation efficiency and the directivity is realized.

### Radiation Efficiency Optimization

After the optimal geometric structure of the 3D stereoscopic superdirective antenna is selected, an input impedance of an antenna array feed circuit and an input impedance of the antenna may not be equal, such that there is an impedance mismatching problem. The antenna radiation efficiency can be further improved by adjusting the impedance matching. As can be seen from circuit theory, for a radiating element having an input complex impedance

$$Z = R + j ( ω L - \frac{1}{ω C} ) ,$$

the optimal value of the input impedance of the feeding end is

$${Z}_{opt} = R - j ( ω L - \frac{1}{ω C} ) = {Z}^{*} .$$

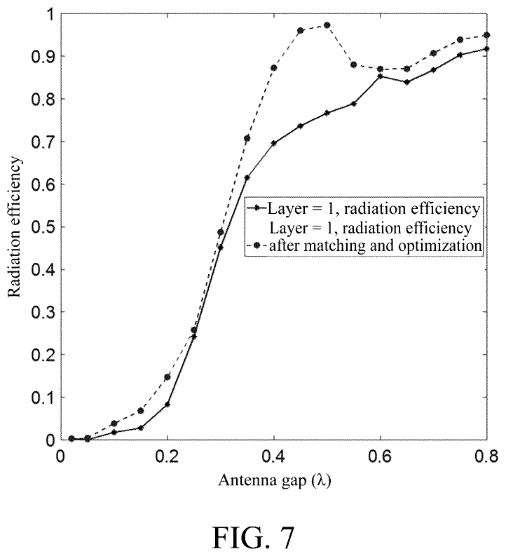

That is, the optimal input impedance of the feeding end is a conjugate of the input complex impedance of the antenna. Since the complexity of dynamically adjusting an arbitrary complex impedance in an actual circuit is very high, implementing impedance matching only by means of amplitude is considered, so as to improve the radiation efficiency of the 3D stereoscopic superdirective antenna. In addition, as can be seen from simulation, when the input impedance of the feeding end is changed, the beam generated by the 3D stereoscopic superdirective antenna does not change significantly (i.e., the directivity does not change significantly), but the input impedance of the radiating element changes significantly, so that impedance matching is an iterative optimization process. In each iteration, the input impedances of the different radiating elements are each acquired via simulation, and then the excitation end pure resistance input impedance is set to be equal to the input impedance of the antenna element in amplitude. The 3D stereoscopic superdirective antenna is then excited to acquire a new antenna element input impedance, and this process is repeated. A radiation efficiency optimization result achieved by means of amplitude impedance matching is shown in FIG. 7 below, and it can be seen that a radiation efficiency increase of at least 10% can be substantially achieved.

Embodiment 2: Specific implementation steps of an excitation vector scheme of the present disclosure in a communication scenario of transmission by the 3D stereoscopic superdirective antenna and reception by a plurality of users are as follows.

System modeling of a communication scenario of transmission by the 3D stereoscopic superdirective antenna and reception by a plurality of users: As shown in FIG. 1, the present disclosure studies a downlink of a communication system in which a sending end is equipped with the 3D stereoscopic superdirective antenna, and a receiving end user performs reception. The 3D stereoscopic superdirective antenna is deployed at a base station (BS) end to generate a superdirective beam for a user, thereby improving transmission quality. The 3D stereoscopic superdirective antenna consists of a number Nₜ of densely arranged antenna array elements. It is assumed that the 3D stereoscopic superdirective antenna and a target user are in a random scattering environment, and a direct link and a reflection link via a reflector may be present between the BS and the user. Since the position of the base station is fixed, for the sake of simplicity, it is assumed that two azimuth angles, i.e., an elevation angle and a horizontal angle, of a scatterer relative to the base in the communication environment can be acquired by the base station via a method such as environment sensing or channel estimation. Assuming that there are a number L of scatterers, channel coefficients between the L scatterers and the target user may be represented by a channel vector of L×1.

### 3D Stereoscopic Antenna Design

For the monoplanar linear 3D stereoscopic superdirective antenna and an arbitrary excitation vector, electromagnetic radiation generated by all antenna elements in a plane perpendicular to a linear array is symmetric with respect to the plane of the linear 3D stereoscopic superdirective antenna, so that when there is a focused beam in a direction other than an end-fire direction, there is inevitably a focused beam in a symmetric direction thereof with respect to the plane, and energy cannot form a superdirective focused beam in a single direction.

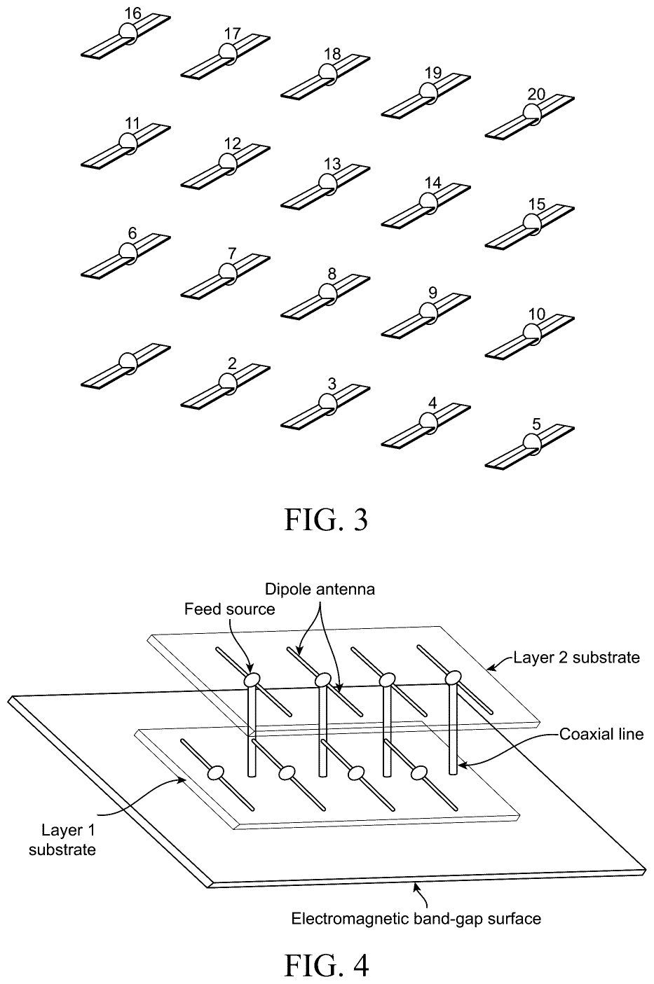

However, in a multi-user communication scenario, it is required that the 3D stereoscopic superdirective antenna of the sending end can simultaneously generate a plurality of superdirective beams directed to the users, and to achieve this objective, the present disclosure proposes constructing a 3D stereoscopic superdirective antenna. Compared with the existing two-dimensional structure of an xy-plane array, the present application further performs multilayer antenna arrangement along the z-axis, so that a superdirective beam can be generated in any direction. For the 3D stereoscopic superdirective antenna (e.g., a 4×1×4 HMIMO array, as shown in FIG. 3), the array has a structure similar to a linear array when seen from a plurality of angles, so that there is a theoretical possibility of simultaneously generating a plurality of superdirective focused beams independently in different directions by means of beamforming excitation vector design, providing a physical basis for realizing a plurality of spatial superdirective beams that are simultaneously directed to a plurality of user positions.

As can be seen from the above principle, the essence of multi-directional superdirective design is still realized by means of a linear array end-fire superdirective design method, so that the 3D stereoscopic superdirective antenna should also have a certain degree of spatial symmetry, and this idea is verified in simulation. An exemplary 3D stereoscopic superdirective antenna provided in the present disclosure is a 5×1×4 structure, as shown in FIG. 3, which can then be further expanded in spatial structure.

Multi-directional superdirective beam generation: Existing beamforming algorithms do not take into account electromagnetic coupling effects between transmission antennas, and a spatial beam formed when the algorithm is applied to the 3D stereoscopic superdirective antenna is affected by coupling distortion, and cannot be directed to the user. The heterogeneous antenna 3D superdirective antenna excitation vector configuration proposed in the present application not only alleviates a beam alignment problem, but also enables a superdirective beam to be generated by means of coupling. In particular, a stacked heterogeneous antenna array can simultaneously generate multi-directional superdirective focused beams directed to a plurality of users. The realized beams are narrow spatially, thereby maintaining low inter-user interference while improving communication quality of the users.

Modeling of the 3D stereoscopic superdirective antenna: First, a dipole array element is modeled in commercial electromagnetic simulation software, and a substrate of an appropriate size is placed below same to meet actual machining requirements. For electromagnetic radiation of a dipole antenna, a well-established analytical expression is already present in the field of electromagnetics. A pattern of a single dipole antenna is simulated by means of the software, and compared with the existing analytical expression in electromagnetic theory, to determine correctness of the modeling. Intensity of a radiating electric field generated by the modeled dipole antenna along the Z-axis follows a sin(θ) distribution pattern, which is consistent with an analytical expression result. θ is an elevation angle in the spherical coordinate system, and φ is a horizontal azimuth angle in the spherical coordinate system. A modeled dipole array is then spread out at equal intervals in one plane to form a linear HMIMO array (as shown in FIG. 2), and finally spread out in a perpendicular plane to form a 3D array (as shown in FIG. 3). Each antenna array element has theoretically the same radiation pattern, but because of coupling effects, the actual radiation pattern of each antenna array element needs to be simulated. An actual manufacturing model of the 3D antenna is shown in FIG. 4.

Spherical wave expansion of the radiation pattern: When the 3D stereoscopic superdirective antenna of a dense antenna is modeled, electromagnetic coupling between array elements thereof needs to be calculated. First, radiation patterns generated by all arrays when there is no coupling need to be recorded. Because spatial coordinates of different antenna elements are different, the radiation patterns thereof are the same when there is no coupling. When observed in the near field, intensity and phases of electromagnetic radiation received at the same receiving point from different transmission antennas are different, so that an uncoupled radiation mode thereof needs to be recorded according to actual spatial positions of the antenna array elements after modeling of the 3D stereoscopic superdirective antenna. This is implemented by performing array factor configuration on a single dipole element. In the array factor configuration, spatially linear superposition of the radiation fields of different elements being individually excited can be generated by means of specifying coordinate differences between the different antenna elements and excitation coefficients of the antenna elements. Electric fields generated by the different elements in this manner are dependent only on the spatial positions and the excitation coefficients thereof, so that the coupling effects of other radiating elements are naturally not included. The space is discretized into P directions (both an elevation angle and a horizontal angle of spherical coordinates are uniformly divided), and 0 direction and φ direction electric field intensity of each direction is recorded as a radiation field of an array element currently being solved.

Second, it is necessary to calculate the radiation patterns of the different antenna array elements when there is coupling. A simulation method includes: after all the antenna array elements of the 3D stereoscopic superdirective antenna are modeled in the simulation software, when configuring excitation of the array, exciting only an antenna array element unit requiring solving, to cause same to generate electromagnetic radiation, connecting all the other antenna array elements to a matching impedance network as a load, likewise discretizing the space into P directions, and recording θ direction and φ direction electric field intensity of each direction. Further, this process is repeated for all modeled antenna array elements, and a radiation field generated when all the array elements are individually excited is recorded.

Finally, after the radiation fields in the case of coupling and in the case of no coupling are each acquired, the radiation fields can be expanded by means of a spherical wave coefficient:

$$E ( r , θ , ϕ ) = κ \sqrt{Z} {\sum }_{s = 1}^{2} {\sum }_{n = 1}^{N} {\sum }_{m = - n}^{n} {Q}_{s , m , n} {F}_{s , m , n} ( r , θ , ϕ )$$

$$κ = \frac{2 π}{λ}$$

is the number of waves, λ is the wave length of electromagnetic waves of an operating frequency, Z is a free-space impedance, (r, θ, φ) is a coordinate parameter of a spherical coordinate system, the three parameters (s, n, m) represent an electromagnetic wave mode (TE/TM waves), an electromagnetic wave expansion dimension, and an electromagnetic wave expansion order, respectively, Q_{s,m,n} is a spherical wave expansion coefficient, and F_{s,m,n}(r, θ, ϕ) is a spherical wave function, and as a set of complete basis functions in space, can be used to describe an arbitrary spatial radiation field. Specific expressions thereof are as follows:

$$\begin{matrix}{F}_{m n} ( r , θ , ϕ ) = \frac{1}{\sqrt{2 π}} \frac{1}{\sqrt{n ( n + 1 )}} {( - \frac{m}{\vert m \vert} )}^{m} {z}_{n} ( κ r ) {P}_{n}^{\vert m \vert} ( cos θ ) {e}^{i m ϕ} \\ {F}_{1 mn} ( r , θ , ϕ ) = ∇ {F}_{m n} ( r , θ , ϕ ) \times \hat{r} \\ = \frac{1}{\sqrt{2 π}} \frac{1}{\sqrt{n ( n + 1 )}} {( - \frac{m}{\vert m \vert} )}^{m} \{ {z}_{n} ( κ r ) \frac{i m {P}_{n}^{\vert m \vert} ( cos θ )}{sin θ} {e}^{i m ϕ} {e}_{θ} - {z}_{n} ( κ r ) \frac{i m {P}_{n}^{\vert m \vert} ( cos θ )}{sin θ} {e}^{i m ϕ} {e}_{ϕ} \} \\ {F}_{2 m n} = {κ}^{- 1} ∇ \times {F}_{1 m n} ( r , θ , ϕ )\end{matrix}$$

The spherical wave function is a set of complete basis functions in space, and can be used to describe an arbitrary spatial radiation field.

zₙ(κr) is an n-order type 1 spherical Hankel function, Pₙ^{|m|}(cos θ) is a normalization related Legendre function, \hat{r} is a unit vector directed to a user in a spherical coordinate system, and e_{θ} and e_{ϕ} are θ direction and φ direction unit vectors, respectively.

Coupling matrix calculation: After the radiation modes of the 3D stereoscopic superdirective antenna in the case of no coupling and in the case of coupling are each obtained, a coupled radiating electric field of a single element can be represented by a linear combination of uncoupled radiating electric fields of a plurality of elements. If the total number of antennas at a sending end is N_{T}, an uncoupled radiation field is e₁^{(o)}, e₂^{(o)}, e₃^{(o)}, . . . , e_{N}_{_{T}}^{(o)}, and a coupled radiation field is as e₁^{(c)}, e₂^{(c)}, e₃^{(c)}, . . . , e_{N}_{_{T}}^{(c)}. The linear expressions are:

$$\begin{matrix}{e}_{1}^{( c )} = {c}_{11} {e}_{1}^{( o )} + {c}_{21} {e}_{2}^{( o )} + … + {c}_{{N}_{T} 1} {e}_{{N}_{T}}^{( o )} \\ {e}_{2}^{( c )} = {c}_{12} {e}_{1}^{( o )} + {c}_{22} {e}_{2}^{( o )} + … + {c}_{{N}_{T} 2} {e}_{{N}_{T}}^{( o )} \\ ⋮ \\ {e}_{{N}_{T}}^{( c )} = {c}_{1 {N}_{T}} {e}_{1}^{( o )} + {c}_{2 {N}_{T}} {e}_{2}^{( o )} + … + {c}_{{N}_{T} {N}_{T}} {e}_{{N}_{T}}^{( o )}\end{matrix}$$

An electric field coefficient e may be introduced as an actually recorded radiating electric field parameter or a spherical wave expansion coefficient, and can be introduced more flexibly as the spherical wave expansion coefficient; the number of expanded items can be adjusted according to required precision. The physical meaning of a linear combination coefficient cₙₘ is the effect of a radiation field of an n-th antenna element on the radiation field of an m-th antenna when there is coupling. As can be seen from the above definition, a link between a coupled electromagnetic field and an uncoupled electromagnetic field is established by means of the coupling matrix, and a coupled field is represented by a linear combination of a plurality of uncoupled fields. Said plurality of formulas may be simplified in the form of a matrix into: E_{N}_{_{T}}^{(c)}=E_{N}_{_{T}}^{(o)}C.

E_{N}_{_{T}}^{(c)} is a recorded coupled electric field, and E_{N}_{_{T}}^{(o)} is a recorded uncoupled electric field, C being a coupling matrix formed by the coupling coefficient cₙₘ. When the matrices E_{N}_{_{T}}^{(c)} and E_{N}_{_{T}}^{(o)} are recorded and acquired via simulation, a calculation formula of the matrix C is: C=E_{N}_{_{T}}^{(o)}^{^{−1}}E_{N}_{_{T}}^{(c)}.

The coupling matrix may be derived from a simulation result according to the above process.

### Superdirective Beam Array Excitation Vector

First, conventional beamforming design is considered. Since the effect of the coupling effect is not considered in the conventional communication model, the excitation vector having undergone conventional beamforming design in the 3D stereoscopic superdirective antenna is not equal to an equivalent excitation vector of an actual antenna array, and the designed excitation vector and the actual equivalent vector are linked by means of the coupling matrix C. Therefore, an excitation vector of a coupled array is an excitation vector of an uncoupled array multiplied by C⁻¹, in order to cause a radiation field of the coupling matrix to conform to a radiation field designed by means of conventional beamforming theory. For a specific array, assuming that an aligned user beam excitation vector designed by means of a conventional beamforming method is a, an excitation vector of the 3D stereoscopic superdirective antenna (which is also a calculation formula of a beamforming module) is C⁻¹a. a=αZ⁻¹e*, α being an energy normalization coefficient, and expressions of the vector e and the matrix Z being as follows:

$$\begin{matrix}e = {[ {e}^{j κ \hat{r} {r}_{1}} k ( θ , ϕ ) , {e}^{j κ \hat{r} {r}_{2}} k ( θ , ϕ ) , … , {e}^{j κ \hat{r} {r}_{{N}_{T}}} k ( θ , ϕ ) ]}^{T} \\ {z}_{m n} = \frac{1}{4 π} {\int }_{0}^{2 π} {\int }_{0}^{π} {\vert g ( θ , ϕ ) \vert}^{2} {e}^{j κ \hat{r} {r}_{m}} {e}^{- j κ \hat{r} {r}_{n}} sin θ d θ d ϕ\end{matrix}$$

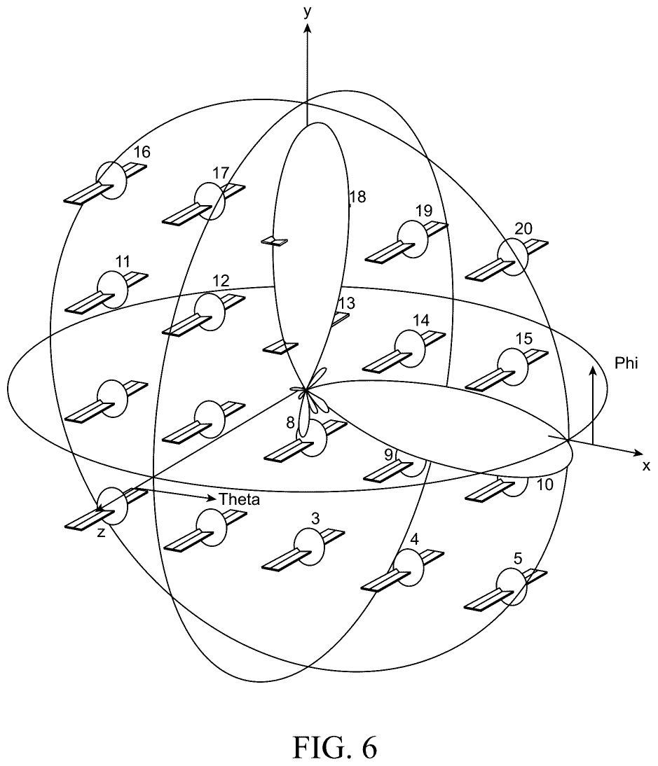

The vector e calculated by the beamforming module is an array response vector of the sending end corresponding to a plurality of receiving users, and is equal to the sum of array response vectors calculated independently for each single user. The matrix Z is defined as a self-impedance matrix of the antenna array, and is determined by an ideal radiation pattern g (θ, φ) of a single radiating element and geometric positions r₁, . . . , r_{N}_{_{T}} of the radiating elements of the antenna array. An excitation circuit consists of a power divider and a phase shifter. The excitation vector calculated by the beamforming module is realized by means of separately adjusting power distribution and a phase of excitation for each antenna. A spatial superdirective beam of a multi-user scenario generated by the excitation circuit is as shown in FIG. 6.

### Multi-Directional Superdirective Radiation Efficiency Optimization

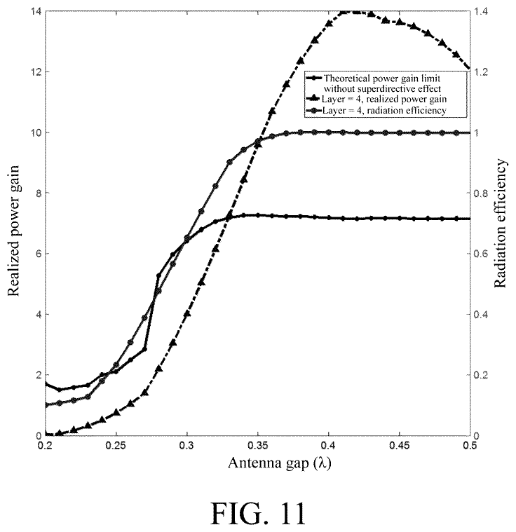

Array structure optimization: Theoretical analysis shows that the directivity which the array can realize increases as the antenna element gap decreases, and for a linear antenna array of N antenna elements, the maximum directivity that can be realized when the element gap d→0 is N². However, it has been found via a simulation experiment that as the element gap d decreases, the coupling effect increases, and antenna radiation efficiency decreases. In addition, a radiation efficiency jump region exists in the range of d=0.35→0.2 (the antenna radiation efficiency decreases sharply). A decrease in antenna radiation efficiency means that an increase directivity does not necessarily result in an improvement in actual energy efficiency, because actually realized antenna power gain=efficiency*Directivity. When the antenna gap is overly large, radiation efficiency is high, but the directivity that can be realized is low. When the antenna gap is overly small, directivity is high, but radiation efficiency is overly low, both of which result in realizable power gain being overly small. Therefore, design of the geometric structure of the array must be optimized. FIG. 11 shows power gains that can be realized by a stacked heterogeneous antenna with different array intervals. As can be seen from the drawing, when the array interval is about 0.4, the maximum realizable gain is realized for the 3D stereoscopic superdirective antenna array, i.e., an optimal trade-off between the radiation efficiency and the directivity is realized.

### Radiation Efficiency Optimization

After the optimal geometric structure of the 3D stereoscopic superdirective antenna is determined, an input impedance of an antenna array feed circuit and an input impedance of the antenna may not be equal, and there is an impedance mismatching problem. The antenna radiation efficiency can be further improved by adjusting the impedance matching. As can be seen from circuit theory, for the 3D stereoscopic superdirective antenna having an input complex impedance

$$Z = R + j ( ω L - \frac{1}{ω C} ) ,$$

the optimal value of the input impedance of the feeding end is

$${Z}_{opt} = R - j ( ω L - \frac{1}{ω C} ) = {Z}^{*} .$$

That is, the optimal input impedance of the feeding end is a conjugate of the input complex impedance of the antenna. Since the complexity of dynamically adjusting an arbitrary complex impedance in an actual circuit is very high, implementing impedance matching only by means of amplitude is considered, so as to improve the radiation efficiency of the 3D stereoscopic superdirective antenna. In addition, as can be seen from simulation, when the input impedance of the feeding end is changed, the beam generated by the 3D stereoscopic superdirective antenna does not change significantly (i.e., the directivity does not change significantly), but the input impedance of the radiating element changes significantly, so that impedance matching is an iterative optimization process. In each iteration, the input impedances of the different radiating elements of the 3D stereoscopic superdirective antenna are each acquired by means of simulation, and then the excitation end pure resistance input impedance is set to be equal to the input impedance of the antenna element in amplitude. The 3D stereoscopic superdirective antenna is then excited to obtain a new antenna element input impedance, and this process is repeated. A condition for ending the cycle is that the radiation efficiency of the array exceeds a preset threshold or the number of cyclic optimizations reaches a preset maximum number of optimizations. A radiation efficiency optimization result achieved by means of the amplitude impedance matching is shown in FIG. 7 below, and it can be seen that a radiation efficiency increase of at least 10% can be substantially achieved, thereby realizing a practical superdirective array.

The function and effect of the present disclosure are further shown via the following simulation experiments.

### (1) A Single-User Scenario of the Single-Layer 3D Stereoscopic Superdirective Antenna

(1.1) Simulation Conditions: It was assumed that the number of users was K=1, and the operating frequency of the antenna array was 1.6 GHz. The antenna array consisted of microstrip dipole antennas. For simplicity, for a heterogeneous HMIMO array, an antenna array deployed in the x-y plane was considered. The antenna elements were arranged along the x-axis, and the multilayer antennas were arranged along the y-axis. In the simulation, two cases of the 3D stereoscopic superdirective antenna were considered: the area of the array aperture was constant, and the number of antennas was inversely proportional to the antenna interval; and the total number of antennas was constant, and the array aperture was proportional to the antenna interval. In addition, it was assumed in the simulation that the user was on an extension line of the positive direction of the x-axis, so that the elevation angle from the 3D stereoscopic superdirective antenna to each user was

$${θ}^{e} = \frac{π}{2} ,$$

and the horizontal azimuth angle was θ^{α}=0. The excitation energy of the antenna array was set to 1 W in the simulation.

During simulation, the 3D antenna analog excitation vector method of the present disclosure was compared with the existing maximum directivity beamforming method of the MIMO array without considering coupling, with respect to two indicators, i.e., the directivity realized by the array and the realized gain.

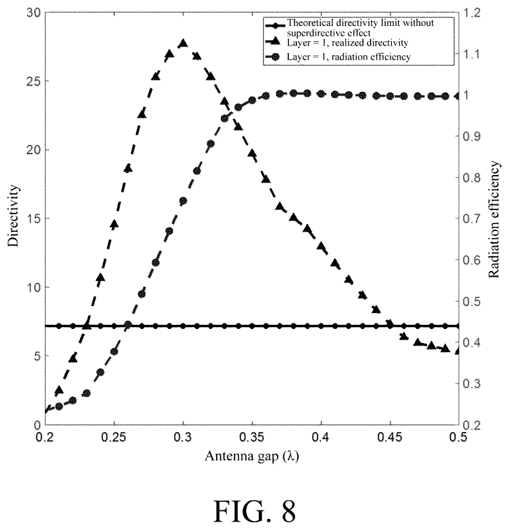

(1.2) Simulation Result: FIG. 8 and FIG. 9 illustrate the effect of the antenna element gap on array directivity, realizable gain, and radiation efficiency when the antenna array aperture area is fixed. For the same simulation scenario setting, it can be seen from the simulation result that as the antenna element gap decreases, the realizable superdirectivity thereof increases gradually, because the superdirective analog excitation vector method provided in the present disclosure is based on coupling effects between the radiating elements of the 3D stereoscopic superdirective antenna. When the element gap decreases, the array coupling effect is correspondingly enhanced, and the corresponding superdirectivity is improved. The leftmost directivity shows a downward tendency because the actual radiation pattern of the array cannot be represented by the linear combination of the ideal patterns of the array elements, which is insufficient for the coupling application. However, it can be seen from the radiation efficiency curve that the coupling effect causes the radiation efficiency of the antenna array to decrease, thereby decreasing the ratio of conversion of directivity gain into actual power gain for antenna transmission. Therefore, there is a trade-off relationship between directivity and radiation efficiency, and as a result of the trade-off between the two factors, the realizable gain curve presents the trend of first rising and then falling. In the small gap portion, the realizable gain is not high due to the overly low radiation efficiency. In the large gap portion, since the coupling effect of the antenna elements is weak, superdirectivity is not obvious. The application of the heterogeneous antenna structure and the proposed 3D superdirective antenna excitation vector configuration in the region where the radiation efficiency is high and the coupling effect is strong realizes high antenna power gain, thereby effectively reducing communication energy loss or improving the communication rate.

### (2) A Multi-User Scenario of the 3D Stereoscopic Superdirective Antenna

(2.1) Simulation Conditions: It was assumed that the number of users was K=3, and the operating frequency of the antenna array was 1.6 GHz. The antenna array consisted of microstrip dipole antennas. For simplicity, for the 3D stereoscopic superdirective antenna, an antenna array deployed in the x-y plane was considered. The antenna elements were arranged along the x-axis, and the multilayer antennas were arranged along the y-axis. In the simulation, two cases of the 3D stereoscopic superdirective antenna were considered: the area of the array aperture was constant, and the number of antennas was inversely proportional to the antenna interval; and the total number of antennas was constant, and the array aperture was proportional to the antenna interval. In addition, it was assumed in the simulation that the users were uniformly distributed on the x-y plane, so that the elevation angle from the 3D stereoscopic superdirective antenna to each user was

$${θ}_{k}^{r} = \frac{π}{2} ,$$

and the horizontal azimuth angle was randomly distributed within [0,π/2]. The excitation energy of the antenna array was set to 1 W in the simulation.

During simulation, the 3D antenna analog excitation vector method of the present disclosure was compared with an existing maximum directivity beamforming method of a MIMO array without considering coupling with respect to two indicators, i.e., the directivity realized by the array and the realized gain.

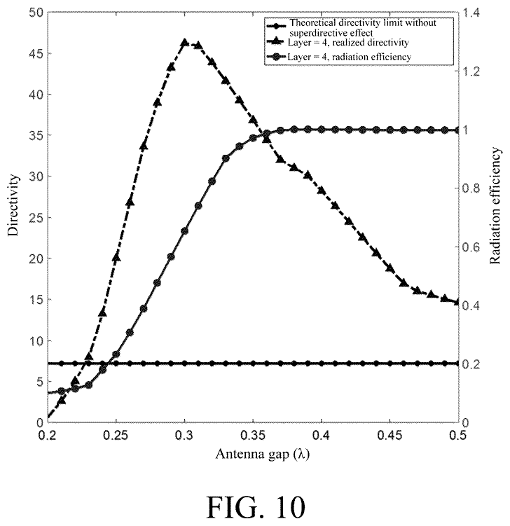

(2.2) Simulation Result: FIG. 10 and FIG. 11 illustrate the single-user analog excitation vector result and the multi-user excitation vector result of the 3D stereoscopic superdirective antenna, and illustrate the effect of the antenna element interval on the array directivity, the realizable gain, and the radiation efficiency when the antenna array aperture area is fixed. From the simulation result, it can be seen that the provided 3D stereoscopic superdirective antenna array and multi-user excitation vector method can generate, at the same time in space, a plurality of superdirective beams that do not interfere with each other, thereby ensuring less mutual interference between users via high directivity while increasing the communication rate of each user. Similarly, as the antenna element gap decreases, the realizable superdirectivity thereof increases gradually, because the superdirective analog excitation vector method provided in the present disclosure is based on the coupling effect between the radiating elements. When the element gap decreases, the array coupling effect is correspondingly enhanced, and the corresponding superdirectivity is improved. The leftmost directivity shows a decreasing tendency because the actual radiation pattern of the array cannot be represented by the linear combination of the ideal patterns of the array elements, which is insufficient for the coupling application. However, it can be seen from the radiation efficiency curve that the coupling effect causes the radiation efficiency of the antenna array to decrease, thereby decreasing the ratio of conversion of directivity gain into actual power gain for antenna transmission. Therefore, there is a trade-off relationship between directivity and radiation efficiency, and as a result of the trade-off between the two factors, the realizable gain curve presents the trend of first rising and then falling. In the small gap portion, the realizable gain is not high due to the overly low radiation efficiency. In the large gap portion, since the coupling effect of the antenna elements is weak, superdirectivity is not obvious. The application of the heterogeneous antenna structure and the proposed 3D superdirective antenna excitation vector method in the region where radiation efficiency is high and the coupling effect is strong realizes high antenna power gain, thereby effectively reducing communication energy loss or improving the communication rate.

From the above results, it can be seen that the present disclosure realizes not only high directivity for superdirective beamforming, but also a small calculation amount and a low delay.

In some examples, described in the present disclosure is a 3D superdirective antenna design and implementation method that is equally applicable to large-scale MIMO communication in a 5G network. In various examples, the disclosed 3D superdirective antenna may use a plurality of dual-polarization or single-polarization radiating elements arranged in a single-row or multi-row array, and the analog excitation coefficient is adjusted using the coupling effect, so as to generate a more desirable spatial radiation pattern and superdirective beams.

The disclosed analog excitation vector design algorithm for the 3D superdirective antenna can utilize mutual coupling effects between radiating elements while realizing a practical superdirective beam.

The disclosed various examples in the antenna array can be applied to beam focusing at any position in space, and the direction of the superdirective beam can be adjusted in real time in practical applications.

Described in the present disclosure are examples of the 3D stereoscopic superdirective antenna capable of generating a superdirective beam of any direction. The disclosed 3D stereoscopic superdirective antenna includes the densely arranged radiating element arrays and the excitation module. The coupling between the radiating element arrays results in a difference between the theoretical radiation pattern and the actual radiation pattern of the 3D stereoscopic antenna. The disclosed 3D stereoscopic superdirective antenna array excitation vector can generate a superdirective beam of any spatial direction using coupling, thereby focusing energy to a target user direction. The disclosed 3D stereoscopic superdirective antenna can be used for large-scale MIMO communication, thereby introducing into the communication system radio frequency characteristics of an antenna and electromagnetic coupling effects that have not been considered in the past, improving communication rates, and realizing a superdirective beam having actual gain.

The present disclosure may be embodied in other specific forms without departing from the subject matter of the claims. The described exemplary embodiments are in all respects merely illustrative, rather than restrictive. Selected features in one or more of the above-described embodiments may be combined to create alternative embodiments not explicitly described, and all features suitable for such combinations are understood to fall within the scope of the present disclosure. For example, although a certain size and a certain shape of the disclosed antenna are shown, other sizes and shapes may be used.

All values and subranges within the disclosed ranges are also disclosed. In addition, although the systems, devices, and processes disclosed and illustrated herein may include a particular number of elements/components, these systems, devices, and components may be modified to include more or fewer such elements/components. For example, although the number of disclosed radiating elements may be a certain fixed number, the embodiments disclosed herein may be modified to include more or fewer such elements/components. The subject matter described herein is intended to cover and encompass all suitable technical variations.

1.-10. (canceled)

11. A three-dimensional (3D) superdirective antenna, comprising:
a multilayer substrate;
a plurality of radiating elements each mounted on the multilayer substrate to form a 3D radiating element array; and
an excitation module comprising an excitation circuit and a beamforming module operatively coupled to the excitation circuit, wherein the beamforming module is configured to:
measure a first plurality of radiation fields generated by the 3D radiating element array without coupling between the plurality of radiating elements;
measure a second plurality of radiation fields generated by the 3D radiating element array with coupling between the plurality of radiating elements;
generate a coupling matrix based on spherical wave coefficient expansion of the first plurality of radiation fields and the second plurality of radiation fields;
determine a superdirective excitation vector based on the coupling matrix; and
transmit a control signal to the excitation circuit that is configured to excite the plurality of radiating elements based on the superdirective excitation vector to generate a superdirective beam.

12. The 3D superdirective antenna of claim 11, wherein the plurality of radiating elements are spaced less than half a wavelength apart to achieve mutual coupling.

13. The 3D superdirective antenna of claim 11, wherein the 3D radiating element array comprises a single row of the plurality of radiating elements.

14. The 3D superdirective antenna of claim 11, wherein the 3D radiating element array comprises a plurality of rows of the plurality of radiating elements that are situated on one plane.

15. The 3D superdirective antenna of claim 11, wherein the 3D radiating element array comprises a plurality of rows of the plurality of radiating elements that are situated on different planes.

16. The 3D superdirective antenna of claim 11, wherein:
the plurality of radiating elements comprise dipole elements that are each configured to ensure that an antenna radiation field intensity along a z-axis follows a sin(θ) distribution pattern, wherein θ represents a horizontal elevation angle.

17. The 3D superdirective antenna of claim 11, wherein the measuring the first plurality of radiation fields comprises:
uniformly dividing spherical coordinates of each of the plurality of radiating elements into respective elevation angles and respective azimuth angles to obtain respective discretized spatial directions;
measuring first respective electric field intensities for the respective elevation angles; and
measuring second respective electric field intensities for the respective azimuth angles.

18. The 3D superdirective antenna of claim 11, wherein the measuring the second plurality of radiation fields comprises:
instructing the excitation circuit to excite a first one of the plurality of radiating elements being measured, wherein remaining ones of the plurality of radiating elements are connected to a matched impedance network;
dividing a spherical coordinate for the first one of the plurality of radiating elements into an elevation angle and an azimuth angle to obtain discretized spatial directions;
measuring a first electric field intensity for the elevation angle; and
measuring a second electric field intensity for the azimuth angle.

19. The 3D superdirective antenna of claim 11, wherein the spherical wave coefficient expansion comprises:
representing each of the second plurality of radiation fields as respective linear combinations of the first plurality of radiation fields and a plurality of coupling coefficients, wherein each of the coupling coefficients represents an effect of a first radiation field of an n-th radiating element on a second radiation field of an m-th radiating element when coupling exists;
adjusting a number of expansion terms within each of the linear combinations based on a required precision level; and
determining the coupling matrix by solving the respective linear combinations.

20. The 3D superdirective antenna of claim 19, wherein:
a total number of antennas at a transmission end is characterized by N_{T},
the first plurality of radiation fields is characterized by E_{N}_{_{T}}^{(o)},
the second plurality of radiation fields is characterized by E_{N}_{_{T}}^{(c)},
the plurality of coupling coefficients is characterized by C,
the plurality of linear combinations is characterized by E_{N}_{_{T}}^{(c)}=E_{N}_{_{T}}^{(o)}C, and
solving the plurality of linear combinations is characterized by C=(E_{N}_{_{T}}^{(o)})⁻¹E_{N}_{_{T}}^{(c)}.

21. The 3D superdirective antenna of claim 11, wherein the determining of the superdirective excitation vector comprises:
linking a first excitation vector designed via a beamforming method to a second actual excitation vector for the radiating element array using the coupling matrix; and
multiplying the first excitation vector by an inverse of the coupling matrix,
wherein a radiation field of the coupling matrix conforms to a radiation field designed via the beamforming method based on the multiplying.

22. The 3D superdirective antenna of claim 21, wherein:
an aligned beam excitation vector designed via the beamforming method is based on a=αZ⁻¹e*,
the superdirective excitation vector is based on C⁻¹a,
α represents an energy normalization coefficient,
e represents an response vector at a transmission end of the array and is based on e=
$$e = {[ {e}^{j κ \hat{r} {r}_{1}} k ( θ , ϕ ) , {e}^{j κ \hat{r} {r}_{2}} k ( θ , ϕ ) , … , {e}^{j κ \hat{r} {r}_{{N}_{T}}} k ( θ , ϕ ) ]}^{T} ,$$
and
Z represents a self-impedance matrix of the array, is based on
$${z}_{m n} = \frac{1}{4 π} {\int }_{0}^{2 π} {\int }_{0}^{π} {\vert g ( θ , ϕ ) \vert}^{2} {e}^{j κ \hat{r} {r}_{m}} {e}^{- j κ \hat{r} {r}_{n}} sin θ d θ d ϕ ,$$
and is determined by an ideal radiation pattern of an radiating element and geometric positions of the radiating elements of the array,
wherein the ideal radiation pattern is based on g (θ, ϕ) and the geometric positions are based on by r₁, . . . , r_{N}_{_{T}}.

23. The 3D superdirective antenna of claim 22, wherein the response vector at the transmission end corresponds to a vector of a plurality of users at the transmission end of a multi-user communication scenario and is equal to a sum of individually calculated response vectors for each of the plurality of users.

24. A method comprising:
performing an array structure optimization for a three-dimensional (3D) superdirective antenna comprising a plurality of radiating elements, the performing the array structure optimization comprising:
simulating a plurality of radiation element spacing intervals to achieve a desired trade-off between a directivity and a radiation efficiency of the antenna; and
determining a desired radiation element spacing interval based on the simulating; and
performing a radiation efficiency optimization for the 3D superdirective antenna via iterative impedance matching.

25. The method of claim 24, wherein the performing the radiation efficiency optimization comprises:
receiving, via simulation, a plurality of initial input impedances corresponding to the plurality of radiating elements;
configuring respective feed ports of each radiating element with respective pure resistance input impedances matched to respective magnitudes of measured impedances of the radiating elements;
controlling the antenna to excite the plurality of radiating elements;
receiving a plurality of new respective input impedances based on the controlling; and
iterating until a radiation efficiency of the antenna exceeds a predetermined threshold or a iteration limit is reached.
